(19) United States
(12) Patent Application Publication
(10) Pub. No.: US 2011/0126602 A1
(43) Pub. Date: Jun. 2, 2011

(54) EMULSION POLYMER COATING AGENT, COATED CONTROLLED-RELEASE FERTILIZER AND PREPARATION THEREOF

(75) Inventors: Lianbu Wan, Shandong (CN); Lingchao Fan, Shandong (CN); Qingling Zhang, Shandong (CN); Deqing Chen, Shandong (CN); Yiwu Gao, Shandong (CN); Hongkun Chen, Shandong (CN)

(73) Assignee: SHANDONG KINGENTA ECOLOGICAL ENGINEERING CO., LTD., SHANDONG (CN)

(21) Appl. No.: 12/995,456

(22) PCT Filed: May 30, 2008
(86) PCT No.: PCT/CN08/01062

§ 371 Date: Nov. 30, 2010

(51) Int. Cl. C05F 11/00; C08L 67/08; C08K 5/3465; C08K 5/098; B05D 1/12

(52) U.S. Cl. 71/27; 524/845; 524/720; 427/185

(57) ABSTRACT

The present invention relates to a polymer emulsion coating agent, a coating controlled-release fertilizer containing said coating agent, and the method for producing the same. The polymer emulsion coating agent of present invention contains alkyd resin prepolymer with neutralization. The present invention also relates to a coating controlled-release fertilizer, which comprises a fertilizer core and a coating applied thereon, wherein said coating comprises the polymer film containing the polymer emulsion coating agent and optionally the inorganic layer containing inorganic powder outside of the polymer film.

### BACKGROUND OF THE INVENTION

The present invention relates to a polymer emulsion coating agent, a coating controlled-release fertilizer containing said coating agent, and a method for producing the same, belonging to the field of material and fertilizer technology.

The controlled-release fertilizer is the main developing direction in fertilizer field, because the release law of its nutrient matches the nutritive demand of the plant. The polymer coating controlled-release fertilizer has attracted much attention worldwide because of its excellent nutrient controlled-release performance, and it has become the main type of the controlled-release fertilizer.

The related technology of preparing the polymer coating controlled-release fertilizer has been described in the patents, such as U.S. Pat. No. 3,223,518, U.S. Pat. No. 3,475,154, U.S. Pat. No. 4,019,890, U.S. Pat. No. 6,391,454, ZL 00122658.4, CN1569773, CN 1603288, etc. Some technology has realized the industrialization, among which a controlled-release fertilizer coated with thermosetting resin from U.S. Scotts company and a controlled-release fertilizer coated with thermoplastic resin from Chisso-Asahi Fertilizer Co., Ltd. (Japan) are typical representatives. However, a controlled-release fertilizer coated with thermosetting resin has a high production cost, making it difficult to popularize. For a controlled-release fertilizer coated with thermoplastic resin, the main method of preparation is to dissolve the linear polymer in the organic solvent to make the dilute polymer solution, and then coat it on the surface of fertilizer particle, and the polymer material forms a polymer film on the surface of fertilizer particle with the volatilizing of solvent. Obviously, there are shortcomings of these controlled-release fertilizers as follows: the polymer coating material has a high price and production cost; the large amount of organic solvent which is used leads to waste of energy and resource and harm to human and environment. Although the additive solvent recovering system can reduce the above consuming and harm, besides it has a high one-time input and complicated technology, the small amount of organic solvent remaining will slowly volatilize and pollute the environment during storage and application. Furthermore, for the polymer coating controlled-release fertilizer, although the nutrient is completely released, it takes a long time for the polymer residues to degrade, which leads to the pollution of soil attribute to the long-term use.

The preparation of polymer coating controlled-release fertilize with the an aqueous polymer used as coating agent has a advantage of low pollution and low cost, and the related technology of preparing has been described in the patents, such as U.S. Pat. No. 4,549,897, U.S. Pat. No. 5,022,182, U.S. Pat. No. 6,176,893, CN 1939878A, etc. There are some reports on the research result about the polyvinylidene chloride suspension used as fertilize coating agent (Shavia A, etc., Fertilizer Research, 1993, 35:1; (Tzika M, etc., Powder Technology, 2003, 132:16). There are also reports on using waste plastic as the main material to make an aqueous polymer coating controlled-release fertilize recently. The inventors also do some researches on the aqueous polymer emulsion coating agent and coating controlled-release fertilize, as described in the patents, such as Chinese Patent Application No. 200710141886.1, No. 200710141889.5. The above technique partly overcomes shortcomings of the solvent-type polymer coating controlled-release fertilize. However, the raw materials used for synthetizing this kind of coating agent rely on the oil, which has a high cost. Moreover, the polymer in the coating agent is thermoplasticity synthetic resin, and it takes a long time for the polymer residues to degrade in soil after the complete releasing of the nutrient, which also leads to the pollution of soil.

### BRIEF SUMMARY OF THE INVENTION

The present invention is to provide a polymer emulsion coating agent which is low-cost and environmentally friendly, and a coating controlled-release fertilize containing said coating agent. The polymer residues can be degraded in soil with biodegradation after the complete releasing of the nutrient.

The present invention is realized with a polymer emulsion coating agent, which contains alkyd resin prepolymer with neutralization.

It is also provided a method for producing said polymer emulsion coating agent in present invention, which comprises the steps as follows:

Neutralizing the alkyd resin prepolymer with alkali,

optionally adding the emulsifier,

optionally adding the water, and

adding the drier.

It is also provided a coating controlled-release fertilizer and a method for producing said fertilize in present invention. The coating controlled-release fertilizer comprises a fertilizer core and a coating applied thereon, wherein said coating comprises the polymer film containing the polymer emulsion coating agent described in present invention and optionally the inorganic layer containing inorganic powder outside of the polymer film.

Moreover, it is provided a method for producing said coating controlled-release fertilize in present invention, which comprises in a fluidized bed, coating the fertilizer particle with the polymer emulsion coating agent described in present invention, and optionally the process of coating the polymer film with the inorganic powder to form the inorganic layer.

Because the medium of the polymer emulsion coating agent in present invention is water, the harm to environment caused by the organic solvent in traditional polymer coating agent has been eliminated completely. Compared with other synthetic polymer coating materials, the alkyd resin in present invention has a low dependence on oil and a low cost, because its main materials come from renewable plant oil in nature. The polymer residues can be degraded in soil with biodegradation, because the plant oil and aliphatic acid fragments on the polymer chain give the polymer film with biodegradability. Because the preparation process begins with micromolecule, the regulation and control of the controlled-release fertilize's nutrient releasing can be achieved by adjusting the composition and technology of the polymer composition material and adjusting the composition and structure of the film-forming polymer then. In addition, because the polymer coating material in present invention contains functional groups which can associate with hydrone, it has a water retaining capacity.

In the preferred embodiment of present invention, the coating of the controlled-release fertilize comprises the polymer film containing the polymer emulsion coating agent described in present invention and the inorganic layer containing inorganic powder outside of the polymer film. In this preferred embodiment, the outermost layer containing inorganic powder has a good performance of viscosity resistance and wear resistance, and it can also partly play the effect of adjusting nutrient releasing.

The polymer emulsion coating controlled-release fertilize has an advantage of non-toxic, pollution-free, low cost and time controllability in production, storage and use, and the polymer residues can be degraded in soil with biodegradation.

### DETAILED DESCRIPTION OF THE INVENTION

The main raw material of the polymer emulsion coating agent in present invention is alkyd resin prepolymer. In the embodiment of present invention, the alkyd resin prepolymer is first prepared, and after neutralizing with alkali, optionally adding the emulsifier, optionally adding the water, and adding the drier, the polymer emulsion coating agent can be obtained.

### (1) Preparation of the Alkyd Resin Prepolymer

The alkyd resin prepolymer used in present invention is obtained through the copolycondensation reaction of the raw material composition containing plant oil and/or aliphatic acid, polyatomic alcohol derived from plant, at least one constituent selected from C₄-C₂₂ synthetic aliphatic acid, C₄-C₂₂ synthetic aliphatic acid anhydride, aromatic acid and aromatic acid anhydride.

In the preferred embodiment of present invention, the plant oil for preparing the alkyd resin prepolymer is drying oil, semi-drying oil, or a mixture thereof, which includes linseed oil, tung oil, dehydrated castor oil, soybean oil, cottonseed oil, Naskole oil, etc. The aliphatic acid derived from plant is oleic acid, linoleic acid, linolenic acid, tall oil, rosin, or a mixture thereof. Because some aliphatic acids, such as oleic acid, linoleic acid, linolenic acid, etc., are obtained from grease, these aliphatic acids can be obtained by the alcoholysis of the corresponding grease on the spot in the practical operation. The polyatomic alcohol is glycerine, trimethylolpropane, pentaerythritol, sorbitol, diethylene glycol, or a mixture thereof, preferably glycerine, trimethylolpropane and pentaerythritol. The preferred carbon atom number of the C₄-C₂₂ synthetic aliphatic acid/anhydride is 4-22, and the C₄-C₂₂ synthetic aliphatic acid/anhydride is selected from C₄-C₁₂ monoacid, polyacid/anhydride preferably, such as maleic acid, maleic anhydride, fumaric acid, caproic acid, capric acid, adipic acid, decanedioic acid, more preferably C₄-C₂₂ diacid/anhydride, especially adipic acid, decanedioic acid/anhydride. The aromatic acid/anhydride is selected from aromatic monoacid, aromatic diacid, aromatic triacid/anhydride, which includes benzoic acid, phthalic acid, phthalic anhydride, m-phthalic acid, trimellitic acid, trimellitic anhydride, etc., preferably aromatic diacid, triacid/anhydride, especially phthalic anhydride, m-phthalic acid, trimellitic acid and trimellitic anhydride. The aromatic acid/anhydride can be unsubstituted, or substituted by one or more substituent groups selected from C₁-C₆ alkyl, C₁-C₆ alkoxyl, C₁-C₆ halogen alkyl, halogen and nitro. The halogen is selected from fluorine, chlorine, bromine and iodine. The alkyl structure of C₁-C₆ alkyl, C₁-C₆ alkoxyl and C₁-C₆ halogen alkyl is the saturated linear chain or branched hydrocarbyl which has 1-6 carbon atoms, especially 1-4, such as methyl, ethyl, propyl, 1-methyl ethyl, butyl, 1-methyl propyl, 2-methyl propyl, 1,1-dimethyl ethyl, amyl, 1-methyl butyl, 2-methyl butyl, 3-methyl butyl, 2,2-dimethyl propyl, 1-ethyl propyl, hexyl, 1,1-dimethyl propyl, 1,2-dimethyl propyl, 1-methyl amyl, 2-methyl amyl, 3-methyl amyl, 4-methyl amyl, 1,1-dimethyl butyl, 1,2-dimethyl butyl, 1,3-dimethyl butyl, 2,2-dimethyl butyl, 2,3-dimethyl butyl, 3,3-dimethyl butyl, 1-ethyl butyl, 2-ethyl butyl, 1,1,2-trimethyl propyl, 1,2,2-trimethyl propyl, 1-ethyl-1-methyl propyl, 1-ethyl-2-methyl propyl. The C₁-C₆ halogen alkyl is the linear chain or branched saturated hydrocarbyl with 1-6 carbon atoms, wherein the hydrogen atoms in these groups are substituted by the above halogen atoms partly or totally, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chlorine-2-fluoroethyl, 2-chlorine-2,2-difluoroethyl, 2,2-dichloro-2-fluoroethyl, 2,2,2-trichloroethyl, pentafluoroethyl, etc. The C₁-C₆ alkoxyl is the linear chain or branched saturated hydrocarbyl with 1-6 carbon atoms which is connected by the oxygen atom, such as methoxyl, ethyoxyl, OCH₂—C₂H₅, OCH (CH₃)₂, n-butoxyl, OCH (CH₃)—C₂H₅, OCH₂—CH (CH₃)₂, OC (CH₃)₃, n-pentyloxyl, 1-methyl butoxyl, 2-methyl butoxyl, 3-methyl butoxyl, 1,1-dimethyl propoxyl, 1,2-dimethyl propoxyl, 2,2-dimethyl-propoxyl, 1-ethyl propoxyl, n-hexyloxyl, 1-methyl pentyloxyl, 2-methyl pentyloxyl, 3-methyl pentyloxyl, 4-methyl pentyloxyl, 1,1-dimethyl butoxyl, 1,2-dimethyl butoxyl, 1,3-dimethyl butoxyl, 2,2-dimethyl butoxyl, 2,3-dimethyl butoxyl, 3,3-dimethyl butoxyl, 1-ethyl butoxyl, 2-ethyl butoxyl, 1,1,2-trimethyl propoxyl, 1,2,2-trimethyl propoxyl, 1-ethyl-1-methyl propoxyl, 1-ethyl-2-methyl propoxyl, etc.

The copolycondensation reaction in present invention can be operated by the copolycondensation method which is known by those skilled in the art. The temperature of the copolycondensation reaction is 100-280° C. for example, preferably 140-250° C.; the time of the copolycondensation reaction is 1-24 hours, preferably 4-12 hours. The end of the copolycondensation and the quality of the alkyd resin are controlled by the acid number of the resin. The acid number of the resin is the amount of the KOH (milligram) used for neutralizing 1 g of resin (unit: mgKOH/g resin). The mixture solvent of alcohol and ether with equal-volume ratio are used to measure the acid number, according to GB/T2895-1982. The inventors find that the acid number of the alkyd resin prepolymer influences the performance of the polymer which is used as coating agent. Generally speaking, when the prescription of polymerization is fixed, with the increase of the acid number of the alkyd resin prepolymer, the hydrophilicity is better and the production of polymer emulsion is easier. Meanwhile, with the rise of the hydrophilicity of the coating agent, the controlled-release time of the controlled-release fertilize reduces. In present invention, the positive is that the acid number of said alkyd resin prepolymer is 10-150 mgKOH/g resin, preferably 20-120 mgKOH/g resin, more preferably 30-80 mgKOH/g resin, and most preferably 40-70 mgKOH/g resin.

In present invention, the component of the raw material composition used for the polymerization can be adjusted in a large scale as required, wherein the content of the plant oil and/or the aliphatic acid derived from plant and the molar ratio of hydroxyl to carboxyl in the raw material composition can influence the acid number of the prepolymer and the viscosity of the system. The bigger the viscosity of said alkyd resin prepolymer is, the more the cosolvent is used in the following preparation of the coating agent. Preferably, the content of said plant oil and/or aliphatic acid derived from plant is 30-70 wt % of the total weight of the raw material composition, more preferably 40-60 wt %; and the molar ratio of hydroxyl to carboxyl in the raw material composition is 0.8-1.4, preferably 0.9-1.3.

In present invention, the preparation method of said alkyd resin prepolymer is alcoholysis method or aliphatic acid method, and the main difference between them is that the raw material of the former is the plant oil, while that of the latter is the aliphatic acid derived from plant oil. The alcoholysis method is preferred in present invention. The copolycondensation can be carried out in the air or in the inert gas, preferably in the inert gas, and the preferred inert gas is the nitrogen. The copolycondensation can be carried out in the solvent, or in the melting state, the melt copolycondensation is preferred.

### (A) Alcoholysis Method

The alcoholysis method in present invention is the well-known alcoholysis method for those skilled in the art. In the preferred embodiment, plant oil, polyalcohol and at least one constituent selected from C₄-C₂₂ synthetic aliphatic acid, C₄-C₂₂ synthetic aliphatic acid anhydride, aromatic acid and aromatic acid anhydride are added into an agitated reactor, and react for 1-24 hours (preferably 4-12 hours) at the temperature of 100-280° C. (preferably 140-250° C.), while the water generated in the reaction is removed by a dehydrator in time. The alkyd resin prepolymer is obtained after cooling.

In the preferred embodiment of present invention, plant oil, polyalcohol and diacid (and/or its anhydride) are added into the agitated reactor equipped with agitator, reflux condenser, thermometer and protection of nitrogen firstly, and heated to the temperature of 160-260° C. reacting for 0.5-6 hours, preferably heated to the temperature of 200-240° C. reacting for 2-4 hours. Next, the temperature decreases to 120-200° C., and other polyacid (and/or its anhydride) is added, reacting for at least 0.5 hour with heat preservation, while the water generated in the reaction is removed by a dehydrator in time. Optionally, the rosin is added when the temperature decreases to 130-160° C., whose content is 2-20 wt % of the total weight of resin, preferably 3-10 wt %, reacting at this temperature for 5 minutes-2 hours, preferably 10 minutes-0.5 hour. The alkyd resin prepolymer with a certain acid number is obtained after cooling.

### (B) Aliphatic Acid Method

The aliphatic acid method used in present invention is the well-known aliphatic acid method for those skilled in the art. In the preferred embodiment, aliphatic acid derived from plant, polyalcohol and at least one constituent selected from C₄-C₂₂ synthetic aliphatic acid, C₄-C₂₂ synthetic aliphatic acid anhydride, aromatic acid and aromatic acid anhydride are added into an agitated reactor, and react for 1-24 hours (preferably 4-12 hours) at the temperature of 100-280° C. (preferably 140-250° C.), while the water generated in the reaction is removed by a dehydrator in time. The alkyd resin prepolymer is obtained after cooling.

In the preferred embodiment of present invention, aliphatic acid derived from plant, polyalcohol and diacid (and/or its anhydride) are added into the agitated reactor equipped with agitator, reflux condenser, thermometer and protection of nitrogen firstly, and heated to the temperature of 160-260° C. reacting for 0.5-6 hours, preferably heated to the temperature of 200-240° C. reacting for 2-4 hours, while the water generated in the reaction is removed by a dehydrator in time. Next, the temperature decreases to 120-200° C., and other polyacid (and/or its anhydride) is added, reacting for at least 0.5 hour with heat preservation, while the water generated in the reaction is removed by a dehydrator in time. Optionally, the rosin is added when the temperature decreases to 130-160° C., whose content is 2-20 wt % of the total weight of resin, preferably 3-10 wt %, reacting at this temperature for 5 minutes-2 hours, preferably 10 minutes-0.5 hour. The alkyd resin prepolymer with a certain acid number is obtained after cooling.

### (2) Preparation of the Polymer Emulsion Coating Agent

The preparation of the polymer emulsion coating agent comprises the steps as follows:

Neutralizing the alkyd resin prepolymer with alkali,

optionally adding the emulsifier,

optionally adding the water, and

adding the drier.

In the preferred embodiment, the above alkyd resin prepolymer is heated and melted, and the temperature is controlled at 25-120° C., preferably 40-90° C., and more preferably 50-80° C. The alkali is added in the above alkyd resin prepolymer with stirring then. The alkali used for neutralizing is inorganic base, organic base, or a mixture thereof, which is used for neutralizing commonly, including alkali metal hydroxide, alkaline-earth metal hydroxide, amines, etc., such as sodium hydroxide, potassium hydroxide, ammonia water, triethylamine, trimethylamine, triethanolamine and morpholine, preferably ammonia water, triethylamine, trimethylamine, sodium hydroxide and potassium hydroxide. The alkali is preferably used in the form of aqueous solution. Preferably the pH of the system of the above alkyd resin prepolymer after neutralization is 5-10, preferably 7-9.

Optionally, the emulsifier is added in the system, and the emulsifier is selected from anionic emulsifier or the mixture of anionic emulsifier and nonionic emulsifier preferably. The anionic emulsifier is one or several emulsifiers selected from the common anionic emulsifiers in this field, such as RCOONa, ROSO₃Na, RSO₃Na and RC₆H₄SO₃Na, wherein R represents C₈-C₁₈ alkyl, sodium alkyl diphenyl ether disulfonate, disproportionated rosin and sodium alkyl naphthalene sulfonate. The nonionic emulsifier is one or several emulsifiers selected from the common nonionic emulsifiers in this field, such as polyoxyethylene sorbitan fatty acid ester, alkylphenol polyoxyethylene ether, alkyl polyoxyethylene ether, etc. Based on the weight of the alkyd resin, the content of the anionic emulsifier is preferably 0-3.0 weight %, and the content of the nonionic emulsifier is preferably 0-5.0 weight %.

If necessary, the water can be added in the system of the alkyd resin prepolymer after neutralizing. For example, the water is added in the system of the alkyd resin with stirring at the temperature of 30-95° C., preferably 45-85° C., and deionized water and distilled water is preferred. After emulsifying uniformly, the system is cooled to the room temperature. The emulsion of alkyd resin prepolymer with a certain solid content can be obtained by water adding as required.

Adding the drier in the system of the alkyd resin prepolymer after neutralization at the room temperature, the polymer emulsion coating agent is obtained after stirring and mixing uniformly. The drier is the drier which is known by those skilled in the art, which includes main drier and unessential drier activator and/or drier active agent. The main drier can be used alone, or be used with the drier activator and/or drier active agent, or a mixture thereof. The main drier is cobalt salt, manganese salt, or a mixture thereof, preferably cobalt naphthenate and manganese naphthenate, and the content is 0.005-0.5 wt % of the alkyd resin prepolymer, preferably 0.03-0.2 wt %. The drier activator is lead salt, calcium salt, zinc salt, ferrum salt, barium salt, zirconium salt, or a mixture thereof, preferably naphthenate, and the content is 0-0.5 wt % of the alkyd resin prepolymer, preferably 0.01-0.5 wt %. The drier active agent is called as “active agent A” in present invention, which is a mixture of 38 wt % o-naphthisodiazine, 22 wt % ethyl caproate and 40 wt % n-butanol, and the content is 0-2.0 wt % of the alkyd resin prepolymer, preferably 0.05-1.0 wt %, and more preferably 0.1-0.8 wt %.

It should be noted that, when the emulsifier and/or the water are added in the system of the alkyd resin prepolymer, the adding order of the emulsifier, water and drier is not important, and they can be added after the neutralization of the alkyd resin prepolymer with alkali in a random order.

In present invention, the particle diameter of emulsion particle in the polymer emulsion is 50 nanometers to 5 micrometers, preferably 60 nanometers to 1 micrometer, and more preferably 70-300 nanometers. Among which the emulsion particles of nanometer sized and sub-micron sized are preferred, and the advantage is the good stability of the emulsion and the compactness of the obtained polymer film.

The solid content of the polymer emulsion coating agent is 5-70 wt %, preferably 10-50 wt %, more preferably 15-40 wt %, and the viscosity of the coating agent is 10-5000 mPa·S, preferably 50-2000 mPa·S, and more preferably 80-500 mPa·S.

### (3) Coating Controlled-Release Fertilize And Method For Producing the Same

In present invention, the particle of the fertilizer core can be any of the water-soluble fertilizer, which can be a single fertilize, such as nitrogenous fertilizer like urea, phosphorus fertilizer like ammonium phosphate, potash fertilizer like potassium sulfate. The particle of the fertilizer core also can be a compound fertilizer or mixed fertilizer which has an arbitrary proportion of nitrogen, phosphorus and potassium, or other water-soluble plant nutrition constituent.

The method for producing the coating controlled-release fertilizer comprises in a fluidized bed, coating the fertilizer particle with the polymer emulsion coating agent to form the polymer film, and optionally the process of coating the polymer film with the inorganic powder to form the inorganic layer. The process of coating is carried on preferably in a boiling type fluidized bed or a rotating drum fluidized bed. The form of spraying is preferred when coating the polymer emulsion coating agent on the surface of the fertilizer particle.

The process of coating can be carried on in a common way in this field, and the temperature in the fluidized bed is preferably 30-95° C.

In the preferred embodiment of present invention, the fertilizer particle is added into the boiling type fluidized bed or rotating drum fluidized bed and preheated, preferably to the temperature of 70-95° C. The polymer emulsion coating agent, which is preheated preferably, is sprayed uniformly on the fertilizer particle with a double nozzle, such as the polymer emulsion coating agent which is preheated to the temperature no more than 80° C., to form a successive and uniform polymer film. The amount of the polymer emulsion coating agent is adjusted by the size of the fertilizer particle and the demand of the releasing rate of the fertilizer nutrient, wherein calculated by the weight of dry matter, the weight of the polymer film is 5-30% of the total weight of the controlled-release fertilizer, preferably 7-20%.

If necessary, the inorganic powder is sprayed into the fluidized bed later at the temperature of 30-95° C., preferably 70-95° C., and coated uniformly on the surface of the fertilizer particle which is coated with polymer. The amount of the inorganic powder is 0-10 wt % of the total weight of the coating controlled-release fertilizer, preferably 0.5-5 wt %, and more preferably 1-3 wt %.

In the preferred embodiment of present invention, the inorganic powder is talcum powder, diatomaceous earth, imvite, kaolin, calcium carbonate, bentonite, attapulgite, sepiolite powder, or a mixture thereof, preferably talcum powder, diatomaceous earth and calcium carbonate, more preferably the inorganic powder of micron-sized. The particle diameter of the inorganic powder is preferably less than 20 micrometers, more preferably less than 10 micrometers, and most preferably less than 5 micrometers. The talcum powder, diatomaceous earth and calcium carbonate with the particle diameter less than 5 micrometers are the best choices.

### EXAMPLES

The present invention is further illustrated by the following examples, but not specifically limited to the following examples.

The plant oil, aliphatic acid, polyalcohol, polyacid, anhydride, drier, wax and inorganic powder used in the examples are of industrial grade, and the alkali used is a chemical pure reagent, and the water used is deionized water.

The nutrient releasing period of the controlled-release fertilizer in the examples is expressed as a duration (days) demanded from the beginning of the immersion of the fertilizer in still water at 25° C. to the moment of the nutrient releasing rate reaching 80 wt %. The specific method is that, a controlled-release fertilizer is immersed into still water at 25° C., and the nutrient passes through the coating and dissolves into the water. The total amount of dissolved nitrogen is measured by titration after distillation according to GB/T 8572. The total amount of dissolved phosphorus is measured by ammonium vanadate-molybdate colorimetry according to GB/T 8573. The total amount of dissolved potassium is measured by a flame photometer method according to GB/T 8574. The duration (days) demanded from the beginning of the immersion of the fertilizer to the moment of the nutrient releasing rate reaching 80 wt % is considered as the nutrient releasing period of the controlled-release fertilizer.

### Example 1

### (1) Preparation of the Alkyd Resin Prepolymer

480 g of linseed oil, 236 g of trimethylolpropane and 166 g of m-phthalic acid are added into an agitated reactor equipped with stirrer, reflux condenser, thermometer and protection of nitrogen, and heated to the 235° C. reacting for 3.5 hours. Next, the temperature decreases to 175° C., and 73 g of trimellitic anhydride is added, reacting for about 3 hours at this temperature, while the water generated in the reaction is removed by a dehydrator in time. 49 g of rosin is added when the acid number reaches 62 mgKOH/g resin and the temperature decreases to 150° C., reacting for 20 minutes.

### (2) Preparation of the Polymer Emulsion Coating Agent

The alkyd resin prepolymer prepared in step (1) is cooled to 65° C., and 20 wt % ammonia water is added with stirring, adjusting the pH of the system to 7. Next, the deionized water is added, and after stirring and emulsifying uniformly, the system is cooled to the room temperature. Then, 2 g of cobalt naphthenate, 1 g of zirconium naphthenate and 0.5 g of active agent A are added, mixing uniformly, and polymer emulsion coating agent is obtained. The particle diameter of emulsion particle is 143 nanometers; the solid content is 35 wt %; the viscosity is 124 mPa·S.

### (3) Coating of the Fertilizer

5 kg of urea with a particle diameter of 3-4 millimeters (manufactured by Shandong Mingshui Chemical Co., N wt % =46.4%) is added into a boiling type fluidized bed and heated to about 90° C., and then 2.5 kg of the above coating agent preheated to about 80° C. is sprayed on the surface of the fertilizer with a double nozzle, with a spraying speed of 35 g/min. Finally, 100 g of diatomaceous earth with a particle diameter of 3 micrometers is uniformly sprayed on the surface of the fertilizer at the temperature of about 80° C.

When calculated by the weight of dry matter, the urea accounts for 83.7%, the polymer accounts for 14.6%, and the diatomaceous earth accounts for 1.7% in the coating controlled-release fertilize. The nutrient releasing period of the controlled-release fertilize is 116 days.

### Example 2

It is the same as that in example 1. The difference is that the diatomaceous earth is not sprayed.

When calculated by the weight of dry matter, the urea accounts for 85.1%, and the polymer accounts for 14.9% in the coating controlled-release fertilize. The nutrient releasing period of the controlled-release fertilize is 95 days.

### Example 3

It is the same as that in example 1. The difference is that the urea in example 1 is replaced by the compound fertilizer with a particle diameter of 2-4 millimeters (manufactured by Shandong Kingenta Ecological Engineering Co., N—P₂O₅—K₂O wt %=16-16-16%).

When calculated by the weight of dry matter, the compound fertilizer accounts for 83.7%, the polymer accounts for 14.6%, and the diatomaceous earth accounts for 1.7% in the coating controlled-release fertilize. The nutrient releasing period of the controlled-release fertilize is 198 days.

### Example 4

### (1) Preparation of the Alkyd Resin Prepolymer

190 g of linseed oil, 210 g of dehydrated castor oil, 223 g of trimethylolpropane and 148 g of phthalic anhydride are added into an agitated reactor equipped with stirrer, reflux condenser, thermometer and protection of nitrogen, and heated to the 225° C. reacting for 2.5 hours. Next, the temperature decreases to 170° C., and 64 g of trimellitic acid is added, reacting for about 3.5 hours at this temperature, while the water generated in the reaction is removed by a dehydrator in time. 60 g of rosin is added when the acid number reaches 55 mgKOH/g resin and the temperature decreases to 160° C., reacting for 15 minutes.

### (2) Preparation of the Polymer Emulsion Coating Agent

The alkyd resin prepolymer prepared in step (1) is cooled to 75° C., and 20 wt % ammonia water is added with stirring, adjusting the pH of the system to 7.5. Next, the deionized water is added, and after stirring and emulsifying uniformly, the system is cooled to the room temperature. Then, 1.8 g of cobalt naphthenate, 1 g of zirconium naphthenate and 1.5 g of active agent A are added, mixing uniformly, and polymer emulsion coating agent is obtained. The particle diameter of emulsion particle is 196 nanometers; the solid content is 35 wt %; the viscosity is 296 mPa·S.

### (3) Coating of the Fertilizer

5 kg of urea with a particle diameter of 3-4 millimeters (manufactured by Shandong Mingshui Chemical Co., N wt %=46.4%) is added into a boiling type fluidized bed and heated to about 90° C., and then 2 kg of the above coating agent preheated to 85° C. is sprayed on the surface of the fertilizer with a double nozzle, with a spraying speed of 30 g/min. Finally, 120 g of talcum powder with a particle diameter of 3 micrometers is uniformly sprayed on the surface of the fertilizer at the temperature of about 85° C.

When calculated by the weight of dry matter, the urea accounts for 85.9%, the polymer accounts for 12%, and the talcum powder accounts for 2.1% in the coating controlled-release fertilize. The nutrient releasing period of the controlled-release fertilize is 92 days.

### Example 5

It is the same as that in example 4. The difference is that the urea in example 4 is replaced by the potassium sulfate with a particle diameter of 3-5 millimeters (manufactured by Shandong Kingenta Ecological Engineering Co., K₂O wt %=50%).

When calculated by the weight of dry matter, the potassium sulfate accounts for 85.9%, the polymer accounts for 12%, and the talcum powder accounts for 2.1% in the coating controlled-release fertilize. The nutrient releasing period of the controlled-release fertilize is 115 days.

### Example 6

### (1) Preparation of the Alkyd Resin Prepolymer

175 g of linseed oil, 175 g of tung oil, 95 g of cottonseed oil, 215 g of trimethylolpropane, 75 g of phthalic anhydride and 83 g of m-phthalic acid are added into an agitated reactor equipped with stirrer, reflux condenser, thermometer and protection of nitrogen, and heated to the 240° C. reacting for 2.5 hours. Next, the temperature decreases to 180° C., and 48 g of trimellitic acid is added, reacting for about 3 hours at this temperature, while the water generated in the reaction is removed by a dehydrator in time. 50 g of rosin is added when the acid number reaches 48 mgKOH/g resin and the temperature decreases to 160° C., reacting for 20 minutes.

### (2) Preparation of the Polymer Emulsion Coating Agent

The alkyd resin prepolymer prepared in step (1) is cooled to 70° C., and 20 wt % ammonia water is added with stirring, adjusting the pH of the system to 7. Next, the deionized water is added, and after stirring and emulsifying uniformly, the system is cooled to the room temperature. Then, 2 g of cobalt naphthenate and 2.5 g of active agent A are added, mixing uniformly, and polymer emulsion coating agent is obtained. The particle diameter of emulsion particle is 154 nanometers; the solid content is 35 wt %; the viscosity is 158 mPa·S.

### (3) Coating of the Fertilizer

5 kg of urea with a particle diameter of 3-4 millimeters (manufactured by Shandong Mingshui Chemical Co., N wt %=46.4%) is added into a boiling type fluidized bed and heated to about 85° C., and then 1.7 kg of the above coating agent preheated to 80° C. is sprayed on the surface of the fertilizer with a double nozzle, with a spraying speed of 30 g/min. Finally, 120 g of calcium carbonate with a particle diameter of 3.5 micrometers is uniformly sprayed on the surface of the fertilizer at the temperature of about 85° C.

When calculated by the weight of dry matter, the urea accounts for 87.5%, the polymer accounts for 10.4%, and the calcium carbonate accounts for 2.1% in the coating controlled-release fertilize. The nutrient releasing period of the controlled-release fertilize is 95 days.

### Example 7

It is the same as that in example 6. The difference is that the urea in example 6 is replaced by the compound fertilizer with a particle diameter of 2-4 millimeters (manufactured by Shandong Kingenta Ecological Engineering Co., N—P₂O₅—K₂O wt %=16-16-16%).

When calculated by the weight of dry matter, the compound fertilizer accounts for 87.5%, the polymer accounts for 10.4%, and the calcium carbonate accounts for 2.1% in the coating controlled-release fertilize. The nutrient releasing period of the controlled-release fertilize is 185 days.

### Example 8

It is the same as that in example 6. The difference is that the urea in example 6 is replaced by the potassium sulfate with a particle diameter of 3-5 millimeters (manufactured by Shandong Kingenta Ecological Engineering Co., K₂O wt %=50%).

When calculated by the weight of dry matter, the potassium sulfate accounts for 87.5%, the polymer accounts for 10.4%, and the calcium carbonate accounts for 2.1% in the coating controlled-release fertilize. The nutrient releasing period of the controlled-release fertilize is 106 days.

### Example 9

### (1) Preparation of the Alkyd Resin Prepolymer

300 g of tung oil, 125 g of soybean oil, 112 g of trimethylolpropane, 70 g of pentaerythritol and 162 g of m-phthalic acid are added into an agitated reactor equipped with stirrer, reflux condenser, thermometer and protection of nitrogen, and heated to the 235° C. reacting for 3 hours. Next, the temperature decreases to 180° C., and 50 g of trimellitic anhydride is added, reacting for about 3 hours at this temperature, while the water generated in the reaction is removed by a dehydrator in time. 52 g of rosin is added when the acid number reaches 42 mgKOH/g resin and the temperature decreases to 155° C., reacting for 20 minutes.

### (2) Preparation of the Polymer Emulsion Coating Agent

The alkyd resin prepolymer prepared in step (1) is cooled to 70° C., and 20 wt % ammonia water is added with stirring, adjusting the pH of the system to 7. Next, 1.5 g of sodium dodecyl benzene sulfonate and 2 g of octylphenol polyoxyethylene ether are added, and after mixing uniformly, the deionized water is added. The system is cooled to the room temperature after stirring and emulsifying uniformly. Then, 1 g of cobalt naphthenate, 1 g of zirconium naphthenate and 1.5 g of active agent A are added, mixing uniformly, and polymer emulsion coating agent is obtained. The particle diameter of emulsion particle is 72 nanometers; the solid content is 30 wt %; the viscosity is 158 mPa·S.

### (3) Coating of the Fertilizer

5 kg of compound fertilizer with a particle diameter of 2-4 millimeters (manufactured by Shandong Kingenta Ecological Engineering Co., N—P₂O₅—K₂O wt %=16-16-16%) is added into a boiling type fluidized bed and heated to about 85° C., and then 2.2 kg of the above coating agent preheated to 80° C. is sprayed on the surface of the fertilizer with a double nozzle, with a spraying speed of 35 g/min. Finally, 120 g of diatomaceous earth with a particle diameter of 3 micrometers is uniformly sprayed on the surface of the fertilizer at the temperature of about 85° C.

When calculated by the weight of dry matter, the compound fertilizer accounts for 86.5%, the polymer accounts for 11.4%, and the diatomaceous earth accounts for 2.1% in the coating controlled-release fertilize. The nutrient releasing period of the controlled-release fertilize is 175 days.

### Example 10

It is the same as that in example 9. The difference is that the amount of the coating agent decreases to 1.4 kg.

When calculated by the weight of dry matter, the compound fertilizer accounts for 90.3%, the polymer accounts for 7.6%, and the diatomaceous earth accounts for 2.1% in the coating controlled-release fertilize. The nutrient releasing period of the controlled-release fertilize is 83 days.

### Example 11

It is the same as that in example 9. The difference is that the compound fertilizer in example 9 is replaced by the potassium sulfate with a particle diameter of 3-5 millimeters (manufactured by Shandong Kingenta Ecological Engineering Co., K₂O wt %=50%).

When calculated by the weight of dry matter, the potassium sulfate accounts for 86.5%, the polymer accounts for 11.4%, and the diatomaceous earth accounts for 2.1% in the coating controlled-release fertilize. The nutrient releasing period of the controlled-release fertilize is 92 days.

### Example 12

It is the same as that in example 9. The difference is that the 20 wt % ammonia water is replaced by 5 wt % NaOH aqueous solution to adjust the pH to 7.

When calculated by the weight of dry matter, the compound fertilizer accounts for 86.5%, the polymer accounts for 11.4%, and the diatomaceous earth accounts for 2.1% in the coating controlled-release fertilize. The nutrient releasing period of the controlled-release fertilize is 155 days.

### Example 13

### (1) Preparation of the Alkyd Resin Prepolymer

163 g of linoleic acid, 215 g of linolenic acid, 82 g of m-phthalic acid, 75 g of phthalic anhydride and 275 g of trimethylolpropane are added into an agitated reactor equipped with stirrer, reflux condenser, thermometer and protection of nitrogen, and heated to the 240° C. reacting for 3 hours, while the water generated in the reaction is removed by a dehydrator in time. Next, the temperature decreases to 180° C., and 68 g of trimellitic anhydride is added, reacting with heat preservation, while the water generated in the reaction is removed by a dehydrator in time. After about 4 hours, the acid number reaches 55 mgKOH/g resin. When the temperature decreases to 150° C., 60 g of rosin is added, reacting for 25 minutes.

### (2) Preparation of the Polymer Emulsion Coating Agent

The alkyd resin prepolymer prepared in step (1) is cooled to 65° C., and 20 wt % ammonia water is added with stirring, adjusting the pH of the system to 7. Next, the deionized water is added, and after stirring and emulsifying uniformly, the system is cooled to the room temperature. Then, 1.5 g of cobalt naphthenate, 1.5 g of zirconium naphthenate and 1.5 g of active agent A are added, mixing uniformly, and polymer emulsion coating agent is obtained. The particle diameter of emulsion particle is 98 nanometers; the solid content is 35 wt %; the viscosity is 243 mPa·S.

### (3) Coating of the Fertilizer

5 kg of compound fertilizer with a particle diameter of 2-4 millimeters (manufactured by Shandong Kingenta Ecological Engineering Co., N—P₂O₅—K₂O wt %=16-16-16%) is added into a boiling type fluidized bed and heated to about 85° C., and then 2 kg of the above coating agent preheated to 80° C. is sprayed on the surface of the fertilizer with a double nozzle, with a spraying speed of 35 g/min. Finally, 120 g of talcum powder with a particle diameter of 3 micrometers is uniformly sprayed on the surface of the fertilizer at the temperature of about 85° C.

When calculated by the weight of dry matter, the compound fertilizer accounts for 85.9%, the polymer accounts for 12%, and the talcum powder accounts for 2.1% in the coating controlled-release fertilize. The nutrient releasing period of the controlled-release fertilize is 135 days.

1. A polymer emulsion coating agent, wherein said coating agent contains alkyd resin prepolymer with neutralization.

2. A polymer emulsion coating agent according to claim 1, wherein the acid number of said alkyd resin prepolymer is 10-150 mgKOH/g resin, preferably 20-120 mgKOH/g resin, more preferably 30-80 mgKOH/g resin, and most preferably 40-70 mgKOH/g resin.

3. A polymer emulsion coating agent according to claim 1, wherein the solid content of said coating agent is 5-70 wt %, preferably 10-50 wt %, and more preferably 15-40 wt %.

4. A polymer emulsion coating agent according to claim 1, wherein the viscosity of said coating agent is 10-5000 mPa·S, preferably 50-2000 mPa·S, and more preferably 80-500 mPa·S.

5. A polymer emulsion coating agent according to claim 1, wherein the particle diameter of emulsion particle in said coating agent is 50 nanometers to 5 micrometers, preferably 60 nanometers to 1 micrometer, and more preferably 70-300 nanometers.

6. A polymer emulsion coating agent according to claim 1, wherein said alkyd resin prepolymer is obtained through the copolycondensation reaction of the raw material composition containing plant oil and/or aliphatic acid derived from plant, polyatomic alcohol, at least one constituent selected from C4-C22 synthetic aliphatic acid, C4-C22 synthetic aliphatic acid anhydride, aromatic acid and aromatic acid anhydride, and the content of said plant oil and/or aliphatic acid derived from plant is 30-70 wt % of the total weight of the raw material composition, preferably 40-60 wt %; and the molar ratio of hydroxyl to carboxyl is 0.8-1.4, preferably 0.9-1.3.

7. A polymer emulsion coating agent according to claim 6, wherein said plant oil is drying oil, semi-drying oil, or a mixture thereof, preferably linseed oil, tung oil, dehydrated castor oil, soybean oil, cottonseed oil and Naskole oil; said aliphatic acid derived from plant is oleic acid, linoleic acid, linolenic acid, tall oil, rosin, or a mixture thereof; said polyatomic alcohol is glycerine, trimethylolpropane, pentaerythritol, sorbitol, diethylene glycol, or a mixture thereof; said C4-C22 synthetic aliphatic acid/anhydride is selected from C4-C22 monoacid, polyacid/anhydride, preferably C4-C22 diacid/anhydride, and more preferably adipic acid, decanedioic acid/anhydride; said aromatic acid/anhydride is selected from aromatic monoacid, aromatic diacid, aromatic triacid/anhydride, and more preferably phthalic anhydride, m-phthalic acid, trimellitic acid and trimellitic anhydride.

8. A polymer emulsion coating agent according to claim 6, wherein the preparation method of said prepolymer is alcoholysis method or aliphatic acid method, preferably alcoholysis method.

9. A polymer emulsion coating agent according to claim 6, wherein said copolycondensation reaction is solution copolycondensation or melt copolycondensation, preferably melt copolycondensation.

10. A polymer emulsion coating agent according to claim 6, wherein the temperature of said copolycondensation reaction is 100-280° C., preferably 140-250° C.; the time of said copolycondensation reaction is 1-24 hours, preferably 4-12 hours.

11. A method for producing the polymer emulsion coating agent according to claim 1, wherein the method comprises the steps as follows:
Neutralizing the alkyd resin prepolymer with alkali,
optionally adding the emulsifier,
optionally adding the water, and
adding the drier.

12. A method for producing the polymer emulsion coating agent according to claim 11, wherein said alkali is inorganic base, organic base, or a mixture thereof, preferably alkali metal hydroxide, alkaline-earth metal hydroxide and amines, and more preferably ammonia water, triethylamine, trimethylamine, sodium hydroxide and potassium hydroxide; preferably the pH of the system after neutralization is 5-10, preferably 7-9.

13. A method for producing the polymer emulsion coating agent according to claim 11, wherein said emulsifier is selected from anionic emulsifier or a mixture of anionic emulsifier and nonionic emulsifier, based on the weight of the alkyd resin, the content of the anionic emulsifier is preferably 0-3.0 wt %, and the content of the nonionic emulsifier is preferably 0-5.0 wt %.

14. A method for producing the polymer emulsion coating agent according to claim 11, wherein said drier includes main drier and unessential drier activator and/or drier active agent.

15. A method for producing the polymer emulsion coating agent according to claim 11, wherein said main drier is cobalt salt, manganese salt, or a mixture thereof, preferably cobalt naphthenate and manganese naphthenate, and the content is preferably 0.005-0.5 wt % of the alkyd resin prepolymer; said drier activator is lead salt, calcium salt, zinc salt, ferrum salt, barium salt, zirconium salt, or a mixture thereof, and the content is 0-0.5 wt % of the alkyd resin prepolymer, preferably 0.01-0.5 wt %; said drier active agent is a mixture of 38 wt % o-naphthisodiazine, 22 wt % ethyl caproate and 40 wt % n-butanol, and the content is 0-2.0 wt % of the alkyd resin prepolymer, preferably 0.05-1.0 wt %.

16. A coating controlled-release fertilizer, comprising a fertilizer core and a coating applied thereon, wherein said coating comprises the polymer film containing the polymer emulsion coating agent according to claim 1, or the polymer emulsion coating agent and optionally the inorganic layer containing inorganic powder outside of the polymer film.

17. A coating controlled-release fertilizer according to claim 16, wherein calculated by the weight of dry matter, the weight of said polymer film is 5-30% of the total weight of the controlled-release fertilizer, preferably 7-20%.

18. A coating controlled-release fertilizer according to claim 16, wherein the content of the inorganic powder is 0-10 wt % of the total weight of the controlled-release fertilizer, preferably 0.5-5 wt %, and more preferably 1-3 wt %.

19. A coating controlled-release fertilizer according to claim 16, wherein said inorganic powder is talcum powder, diatomaceous earth, imvite, kaolin, calcium carbonate, bentonite, attapulgite, sepiolite powder, or a mixture thereof, preferably talcum powder, diatomaceous earth and calcium carbonate, more preferably micron-sized, preferably the inorganic powder less than 5 micrometers, further preferably talcum powder, diatomaceous earth and calcium carbonate with the particle diameter less than 5 micrometers.

20. A method for producing the coating controlled-release fertilizer according to claim 16, comprising in a fluidized bed, preferably in a boiling type fluidized bed or a rotating drum fluidized bed, coating the fertilizer particle with the polymer emulsion coating agent or the polymer emulsion coating agent to form the polymer film, preferably, spraying said polymer emulsion coating agent on the surface of the fertilizer particle with a double nozzle, and optionally the process of coating the polymer film with the inorganic powder to form the inorganic layer.
